(19) United States
(12) Patent Application Publication
(10) Pub. No.: US 2008/0107138 A1
(43) Pub. Date: May 8, 2008

(54) METHOD AND APPARATUS FOR RECOGNIZING N CHANNELS ACCORDING TO N MULTI-CHANNEL SIGNALS

(75) Inventors: Ching-Yih Tseng, Hsin-Chu (TW); Yu-Chi Chen, Hsin-Chu (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: RDC SEMICONDUCTOR CO., LTD., Hsin-Chu (TW)

(21) Appl. No.: 11/739,491

(22) Filed: Apr. 24, 2007

(30) Foreign Application Priority Data
Nov. 2, 2006 (TW) 095140570

(51) Int. Cl. H04J 3/12

(52) U.S. Cl. 370/524

(57) ABSTRACT

An apparatus and method for a receiver to recognize channel numbers, skew delays, and polarities of N channels by extracting the properties of the transmitted signals are provided. Each of the N signals comprises a plurality of digital symbols with certain characteristics known to the receiver. The apparatus comprises a calculation unit, a statistic unit, and a selection unit. The calculation unit is used to compute a value for each channel according to the properties of the digital symbols captured on that particular channel within a predetermined interval. The statistic unit is used to derive a plurality of statistical values based on the values from the calculation unit. The selection unit recognizes the special property of a channel, identifies the remaining N−1 channels, compensates the skew delays, and corrects polarities.

This application claims priority to Taiwan Patent Application No. 095140570 filed on Nov. 2, 2006.

### CROSS-REFERENCES TO RELATED APPLICATIONS

Not applicable.

### BACKGROUND OF THE INVENTION

1. Field of the Invention

The present invention relates to a method and an apparatus for recognizing N channels according to N multi-channel signals. Specifically, the present invention relates to a method and an apparatus for recognizing N channels according to N multi-channel signals simplified by a digital signal processor.

2. Descriptions of the Related Art

Due to the rapid development of communication technologies, communication systems are able to simultaneously transmit and receive data at multi-channels. Because multi-channel communication systems benefit from fast transmission and high data rates, they have been commonly used. For example, the Gigabit Ethernet applies 4 cables to provide simultaneous four-channel communication between transmitter and receiver to achieve the aggregated 1 Gigabit per second data rate where each channel provides 250 Megabit per second rate.

The design of a multi-channel communication system is more challenging since it has to deal with problems that do not exist for a single channel system. One problem associated with a multi-channel system is that the signals from different channels at the transmitter side may not arrive at the receiver at the same time instant which creates the time skew issue at the receiver side. In addition, the signal polarities may be reversed for some channels while remaining unchanged for the other channels so that a simple phase reversal detection to all channels is not applicable. In order to reconstruct the bit stream correctly at the receiver side, the exact channel label for each channel needs to be identified unambiguously at the receiver side which also requires the receiver be capable of distinguishing the correct channel label for a particular channel. This invention deals with these inherited problems for a multi-channel communication system by use of a set of digital algorithms that can be implemented efficiently by a digital signal processor.

### SUMMARY OF THE INVENTION

The present invention provides an apparatus for recognizing N channels according to N multi-channel signals. Each of the N multi-channel signals comprises a plurality of digital symbols. The apparatus comprises a first calculating module, a statistical module and a screening module. The first calculating module for calculating a plurality of digital symbols is comprised in a predetermined interval of each of the N multi-channel signals to derive a calculated value. The first calculating module further repeats the calculating step to calculate a plurality of predetermined intervals to derive a plurality of calculated values. The statistical module is used for counting the calculated values of the N multi-channel signals and for generating a plurality of statistical values according to the calculated values. The screening module is used for screening the N channels to derive both a first recognized channel and N−1 unrecognized channels according to the statistical values. The present invention provides a method for recognizing N channels according to N multi-channel signals comprising the following steps: (a) calculating a plurality of digital symbols comprised in a predetermined interval of each of the N multi-channel signals to derive a calculated value; (b) repeating the calculating step to calculate a plurality of predetermined intervals to derive a plurality of calculated values; (c) counting the calculated values of the N multi-channel signals; (d) generating a plurality of statistical values according to the calculated values; and (e) screening the N channels to derive a first recognized channel according to the statistical values. According to the aforementioned arrangements and steps, the present invention first recognizes the N unrecognized channel signals after the operations of the digital signal processor, then aligns the N recognized signals, and finally, adjusts the polarities of the N recognized signals. Since the digital signal processor already simplifies the digital symbols comprised in the N unrecognized channel signals, the present invention is able to recognize the channel label of each channel, align the time skew and adjust the polarity very efficiently.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a schematic diagram of a first embodiment of the invention;

FIG. 2 illustrates a schematic diagram of an N channel recognizing apparatus of the first embodiment;

FIG. 3 illustrates a schematic diagram of a w channel signal;

FIG. 4 illustrates a schematic diagram of a determined interval of four aligned channel signals;

FIG. 5A illustrates a flow chart of the invention;

FIG. 5B illustrates a detailed flow chart of step 54;

FIG. 5C illustrates a detailed flow chart of step 55; and

FIG. 5D illustrates a detailed flow chart of step 59.

### DESCRIPTION OF THE PREFERRED EMBODIMENT

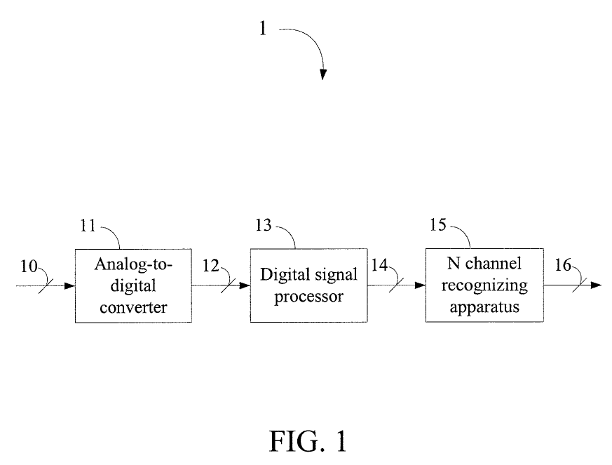

FIG. 1 shows a schematic diagram of a first embodiment of the invention, which is a receiving system 1 of the Gigabit Ethernet. In this embodiment, the Gigabit Ethernet consists of four transmission channels. However, the present invention is applicable to a system with any number of transmission channels greater than or equal to two. In the first block of this embodiment, the receiving system 1 is used for receiving four analog channel signals 10 that are transmitted via the four transmission channels of the Gigabit Ethernet. The receiving system 1 comprises an analog-to-digital converter 11, a digital signal processor 13, and an N channel recognizing apparatus 15. The analog-to-digital converter 11 is used to convert the four received analog channel signals 10 into four digital channel signals 12, whereas each of the digital channel signals 12 comprises a plurality of digital symbols. The digital signal processor 13 is used to process the four digital channel signals 12 to reconstruct the unrecognized channel signals 14 to feed into the N-channel recognizing apparatus for resolving the desired characteristics of the digital symbols. In this embodiment, the unrecognized channel signals 14 are mapped into only five possible values of (−2, −1, 0, 1, 2).

The N channel recognizing apparatus 15 is an apparatus for recognizing N channels according to the characteristics of N multi-channel signals. In other words, the N channel recognizing apparatus 15 receives and then processes the unrecognized channel signals 14 into recognized unrecognized channel signals for further alignment and polarity adjustment of each of the channels. For convenience, the four channels before recognition are denoted as (w,x,y,z), whereas the four channels after recognition are denoted as (a,b,c,d), respectively. In addition to recognizing the N channels by their channel labels, the N channel recognizing apparatus 15 also compensates the various channel signal displacements and adjusts the polarity of the channel signals to obtain four recognized channel signals with aligned time index and correct polarity 16.

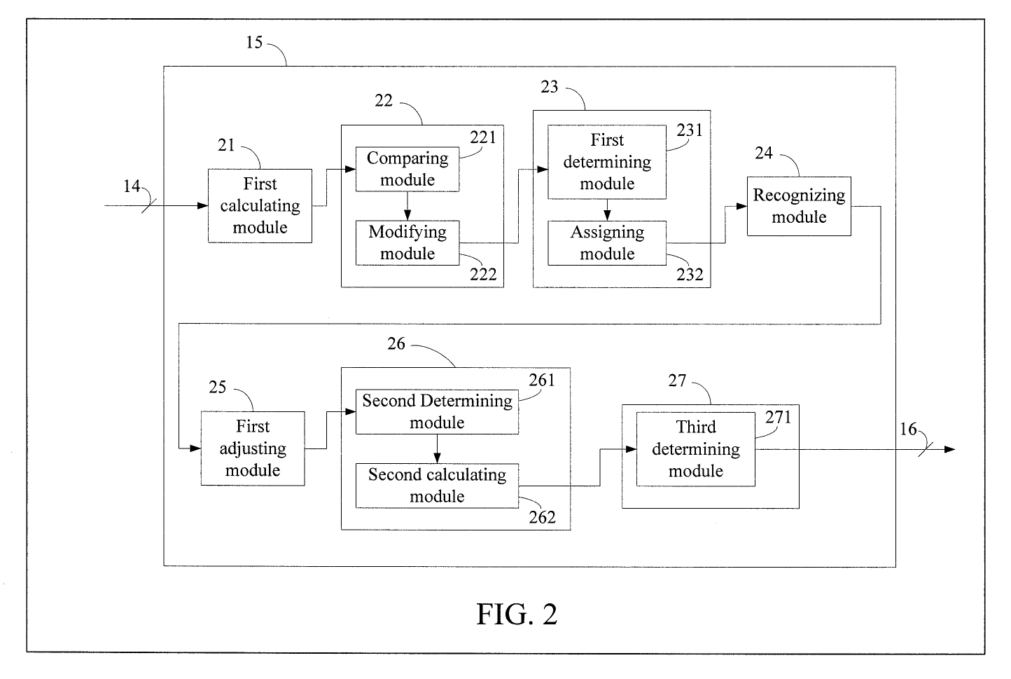

As shown in FIG. 2, the N channel recognizing apparatus 15 comprises a first calculating module 21, a statistical module 22, a screening module 23, a recognizing module 24, a first adjusting module 25, a generating module 26 and a second adjusting module 27. The statistical module 22 comprises a comparing module 221 and a modifying module 222. The screening module 23 comprises a first determining module 231 and an assigning module 232. The generating module 26 comprises a second determining module 261 and a second calculating module 262. The second adjusting module 27 comprises a third determining module 271.

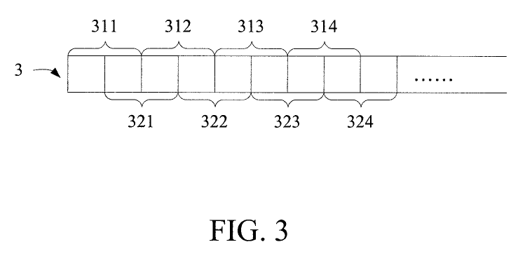

For each of the unrecognized channel signals 14, the first calculating module 21 defines two types of predetermined intervals. The first type of predetermined interval is the interval occupied by two consecutive digital symbols beginning at an odd position. The second type of predetermined interval is the interval occupied by two consecutive digital symbols beginning at an even position. For example, in the w channel signal 3 shown in FIG. 3, the predetermined intervals 311, 312, 313 and 314 are the first type of predetermined intervals, while the predetermined intervals 321, 322, 323 and 324 are the second type of predetermined intervals.

For the predetermined intervals defined by each of the four unrecognized channel signals 14, the first calculating module 21 calculates a plurality of digital symbols comprised within them to derive a calculated value and then repeatedly calculates a plurality of predetermined intervals to derive a plurality of calculated values. In this embodiment, the calculation of the first module 21 is a summation operation for the digital symbols. In addition, using the w channel signal 3 shown in FIG. 3 as an example, the first calculating module 21 sums up the two digital symbols comprised in the predetermined interval 311 to derive a calculated value (i.e., the summation) and repeatedly sums up the digital symbols comprised in the other predetermined intervals to derive a plurality of calculated values (i.e. the summations). For convenience, the calculated values derived from the first type of predetermined intervals are called the first type calculated values, while the calculated values derived from the second type of predetermined intervals are called the second type of calculated values. The number of predetermined intervals required for summation by the first calculating module 21 will be described in detail later. The first calculating module 21 also performs the same summation to the x channel signal, the y channel signal, and the z channel signal.

The statistical module 22 is used to gather the statistics of the calculated values of the N multi-channel signals according to the calculated values (i.e. the summations) and to generate a plurality of statistical values. Specifically, for each of the unrecognized channels 14, the statistical module 22 gathers the statistics twice to obtain two statistical values, wherein one of the statistical values is in accordance with the first type calculated values and is called a first statistical value, while the other statistical value is in accordance with the second type calculated values and is called a second statistical value.

More specifically, the comparing module 221 and the modifying module 222 of the statistical module 22 generate the statistical values. First, the comparing module 221 compares the calculated value with a first predetermined value. In this embodiment, the first predetermined value is 2. Each of the digital symbols comprised in the w channel signal 3 appears in sequence. When each of the digital symbols appears, the first calculating module 21 sums up the digital symbol and the previous digital symbol to derive a calculated value. The comparing module 221 then compares the calculated value with the first predetermined value (i.e., 2). If the calculated value is 2, the modifying module 222 increases the corresponding statistical value by one. Otherwise, the corresponding statistical value is reset to 0. Here, the corresponding statistical value is either the first statistical value or the second statistical value of the w channel signal depending on the type of predetermined interval. In particular, the first calculating module 21 sums up the first type predetermined interval 311 to derive a calculated value. If the comparison result of the comparing module 221 is equal to 2, the modifying module 222 increases the first statistical value of the w channel signal by one. Next, the first calculating module 21 sums up the second type predetermined interval 322 to obtain another calculated value. Assuming that the comparison result of the comparing module 221 is not equal to 2, the modifying module 222 resets the second statistical value to 0. The steps thereafter are performed in a similar manner. The comparing module 221 and the modifying module 222 also perform the same comparison and modifications to the x channel signal, the y channel signal and the z channel signal.

Next, the screening module 23 screens the four channels to obtain a first recognized channel and three unrecognized channels according to the statistical values. In particular, the screening module 23 screens to derive three unrecognized channels according to (1) the first statistical value and the second statistical value of the w channel signal, (2) the first statistical value and the second statistical value of the x channel signal, (3) the first statistical value and the second statistical value of the y channel signal, and (4) the first statistical value and the second statistical value of the z channel signal. The remaining channel is hence the recognized channel and is represented as the first recognized channel.

In more detail, the first determining module 231 and the assigning module 232 of the screening module 23 perform the screening. First, the first determining module 231 is used to determine whether there exist three of the statistical values greater than a second predetermined value, such as, 50. In other words, these modules determine if any of the three channels—x channel signal, y channel signal and z channel signal—have a statistical value greater than 50. For example, in this embodiment, the second statistical value of the w channel, the first statistical value of the x channel, and the first statistical value of the y channel are all greater than 50. Consequently, the assigning module 232 assigns the three multi-channel signals corresponding to the three statistical values as the three unrecognized channel signals, and assigns the remaining multi-channel signal as the first recognized channel signal. Namely, the w, x and y channel signals are assigned as the three unrecognized channel signals, while the z channel signal is assigned as the first recognized channel signal. For convenience, the first recognized channel signal (i.e., the z channel signal) is called the a channel signal. Since the a channel signal has been recognized, the corresponding channel is recognized as well and is called the a channel.

After the assigning module 232 assigns the z channel as the first recognized channel (the a channel) and assigns the w, x and y channels as unrecognized channels, the recognizing module 24 proceeds with the subsequent operations; that is, the recognizing module 24 recognizes the w, x and y channels as the recognized channels of the b, c and d channel signals. The recognizing module 24 recognizes the three unrecognized channels according to a first predetermined interval of the a channel signal, while the digital symbols comprised in a second predetermined interval of each of the w, x, and y channels determines three corresponding displacements among the four recognized channels.

More specifically, the recognizing module 24 stores the last several (a predetermined number) digital symbols of the first recognized channel signal (the a channel signal) and each of the unrecognized channel signals (the w, x and y channel signals). In this embodiment, the predetermined number of digital symbols is 130. Next, the recognizing module 24 defines a first predetermined interval of the first recognized channel signal (the a channel signal) as the three intervals beginning at the 35^{th}, the 48^{th}, and the 56^{th} digital symbol with an interval length of 32 each. Namely, the first predetermined interval comprises the following three intervals: 35^{th}˜66^{th} digital symbols, 48^{th}˜79^{th} digital symbols and 56^{th}˜87^{th} digital symbols, denoted as a₁, a₂ and a₃, respectively. Meanwhile, the recognizing module 24 defines a second predetermined interval for each of the w, x and y channels, respectively. For example, the 47^{th}˜78^{th} digital symbols of the w channel signal, the 39^{th}˜70^{th} digital symbols of the x channel signal, and the 37^{th}˜68^{th} digital symbols of the y channel signal, denoted as w₁, x₁ and y₁, respectively. Each of the second predetermined intervals has a corresponding summation value. The recognizing module 24 compares each of the summations of the w₁, x₁ and y₁ with a₁, a₂ and a₃. Depending on the comparison, the recognizing module 24 labels the one corresponding to the a₁ as the second recognized channel (represented as the b channel signal), the one corresponding to the a₂ as a third recognized channel (represented as the c channel signal), and the one corresponding to the a₃ as a fourth recognized channel (represented as the d channel signal). In this embodiment, the recognizing module 24 recognizes the w channel signal as the c channel signal, the x channel signal as the b channel signal, and the y channel signal as the d channel signal. Since the recognizing module 24 has already recognized four recognized channel signals, the recognizing module 24 can recognize the four transmission channels according to the recognition result of the channel signals.

During the comparison, the recognizing module 24 also calculates three displacements d_{b}, d_{c}, and d_{d} for the b channel signal, c channel signal, and d channel signal corresponding to the a channel signal, respectively. For example, when the 77^{th} digital symbol of the b channel corresponds to the 80^{th} digital symbol of the a channel, a delay of 3 is obtained. The first adjusting module 25 adjusts the corresponding positions of the multi-channel signals comprised in the recognized channels according to the displacement. That is, the digital symbols comprised in the b channel signal, c channel signal, and d channel signal are aligned with the d_{b}, d_{c}, and d_{d} displacements.

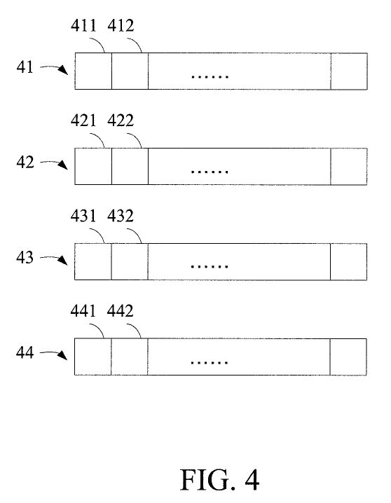

Next, the generating module 26 generates a determined value according to the digital symbols comprised in a determined interval of each of the aligned N recognized channel signals (the aligned a, b, c and d channel signals). In this embodiment, the determined intervals come from the stored 130 digital symbols mentioned above after the completion of alignment. FIG. 4 shows a determined interval of four channel signals after the alignment. Interval 41 represents the first determined interval a₂ of the a channel signal, interval 42 represents the second determined interval b₂ of the a channel signal, interval 43 represents the third determined interval c₂ of the a channel signal, and interval 44 represents the fourth determined interval d₂ of the a channel signal.

More specifically, the second determining module 261 and the second calculating module 262 of the generating module 26 generate the determined values. For the following explanations, determined interval a₂ of the a channel signal is used. The second determining module 261 determines whether each of the digital symbol comprised in the a₂ is equal to a third predetermined value. In this embodiment, the third predetermined value is 0. If the digital symbol is not equal to 0, the second calculating module 262 performs an XOR logical operation to the digital symbol and the corresponding digital symbols in the b₂, c₂ and d₂ to obtain a logical value. After all the digital symbols in the a₂ are processed in the aforementioned manner, a plurality of logical values are obtained. Each of the logical values corresponds to a digital symbol comprised in the a₂, respectively. The second calculating module 262 then sums up the logical values to obtain a determined value. In other words, if the second determining module 261 determines that a digital symbol 411 is not equal to 0, the second calculating module 262 finds out the corresponding digital symbol 421 of the b₂, the corresponding digital symbol 431 of the c₂, and the corresponding digital symbol 441 of the d₂. The second calculating module 262 applies the XOR logical operation to the digital symbols 411, 421, 431 and 441 to obtain a logical value. After all the digital symbols of the determined interval a₂ are processed, the second calculating module 262 sums up the obtained logical values. The generating module 26 also performs the same calculation to the b channel, the c channel, and the d channel to generate a determined value, respectively.

Finally, the second adjusting module 27 adjusts the polarity of each of the four aligned recognized channel signals according to the determined values. Specifically, the third determining module 271 of the second adjusting module 27 completes the polarity adjustment. For example, in the determined interval a₂, the third determining module 271 determines the sign of its corresponding determined values. If the determined value is negative, the sign of each of the digital symbol comprised in the a channel signal is changed. In addition to the determined interval a₂, the third determining module 271 also determines the other three channels to adjust the polarity of each of the digital symbols comprised in the channel signals. As a result, four recognized channel signals 16 that are aligned, and polarity adjustment are obtained.

With the aforementioned configuration, the present invention is able to recognize the N unrecognized channel signals at the back end of the digital signal processor 13 and is able to align and adjust the polarity of the recognized channel signals. Since the digital signal processor 13 has simplified the digital symbols in the N unrecognized channel signal, the invention is able to process efficiently.

As a note, the values and the intervals mentioned in the embodiment, such as the first predetermined interval, the second predetermined interval, the predetermined value, the second predetermined value, and the third predetermined value can all be adjusted according to various conditions. For example, the values can be adjusted according to the contents of the digital symbols. The above values are not used to limit the scope of the invention. Furthermore, the N channel recognizing apparatus can be used to recognize an arbitrary number of channels and does not only recognize the mentioned four channels in the embodiment.

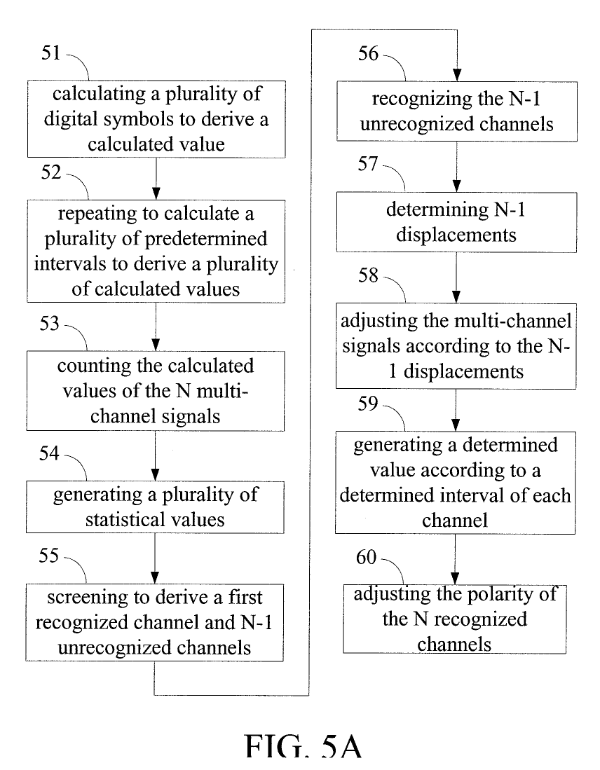

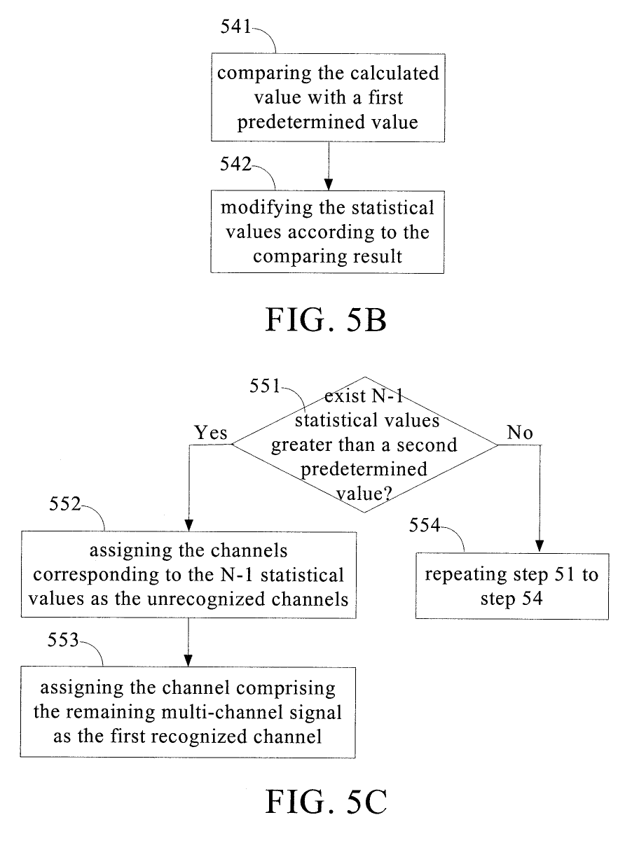

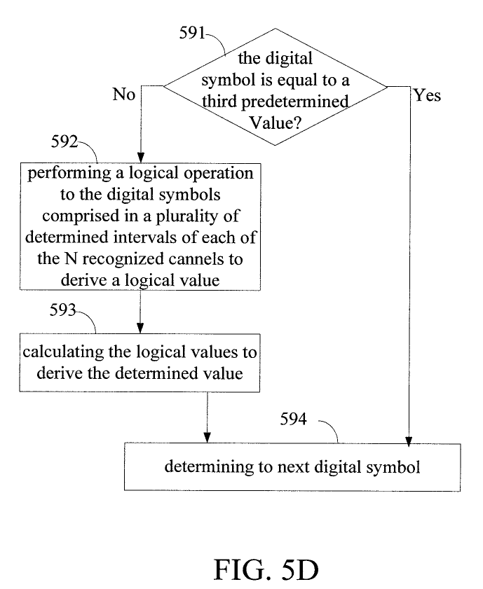

FIG. 5A illustrates a second embodiment of the present invention, which is a method for recognizing N channels according to N multi-channel signals. Each of the N multi-channel signals comprises a plurality of digital symbols. The method executes step 51 first to calculate a plurality of digital symbols comprised in a predetermined interval of each of the N multi-channel signal to derive a calculated value. The predetermined interval and the calculation of the calculated values are similar to the first embodiment, and therefore no further details are given here. Next, step 52 repeats the calculating step 51 to calculate a plurality of predetermined intervals to derive a plurality of calculated values.

Furthermore, step 53 is executed to count the calculated values of the N multi-channel signals according to the calculated values. Next, step 54 is executed to generate a plurality of statistical values according to the calculated values. FIG. 5B shows a detailed flow chart for step 54. Step 541 is executed first to compare the calculated value with a first predetermined value. Step 542 is executed next to modify the statistical values according to the comparison.

Step 55 screens the N channels to derive a first recognized channel and N−1 unrecognized channels according to the statistical values. FIG. 5C shows a detailed flow chart for step 55. Step 551 is executed first to determine whether there are N−1 statistical values greater than a second predetermined value. If so, step 552 assigns the N−1 channels corresponding to the N−1 statistical values as the N−1 unrecognized channels, and step 553 assigns the remaining channel as the first recognized channel. If the N−1 statistical value is not greater than the second predetermined value, step 554 continues the aforementioned calculating and statistical steps.

After screening in step 55, step 56 recognizes the N−1 unrecognized channels according to the digital symbols comprised in a first predetermined interval of the first recognized channel and a second predetermined interval of each of the N−1 unrecognized channels, respectively. Next, step 57 determines N−1 displacements between the N recognized channels. Step 58 then adjusts the multi-channel signals comprised in the N−1 recognized channels according to the N−1 displacements.

Step 59 applies a logical operation to the digital symbols comprised in a plurality of determined intervals of each of the N recognized channels to derive a determined value. FIG. 5D shows a detailed flow chart of step 59. Step 591 is executed first for comparing whether each of the digital symbols is equal to a third predetermined value. If not, step 592 calculates the digital symbol and the digital symbols of the plurality of determined intervals corresponding to the recognized channels to derive a logical value. Step 593 further calculates the logical values to derive the determined values. Next, step 594 determines the next digital symbol. If the result of step 591 is equal, then step 594 is executed for determining the next digital symbol. The steps are repeated to each digital symbol so that a determined value can be determined according to a determined interval for each channel. Finally, step 60 adjusts the polarity of each N recognized channel according to the determined values. If the determined values are negative, a sign of each digital symbol corresponding to the determined values is modified. Now, a recognized, aligned and polarity adjusted N channel is obtained.

With the mentioned steps, the invention can perform alignment and polarity adjustment after simplifying the N unrecognized channel signals. Consequently, the invention proceeds very efficiently. As another note, the first predetermined interval, the second predetermined interval, the predetermined value, the second predetermined value, and the third predetermined value mentioned in the embodiment can all be adjusted according to various conditions. For example, the values can be adjusted according to the contents of the digital symbols. The above mentioned values are not considered as the limitation of the scope of the invention. Furthermore, the N channel recognizing apparatus can be used for recognizing an arbitrary number of channels, which is not limited to the mentioned four channels in the embodiment.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for recognizing N channels according to N multi-channel signals, each of the N multi-channel signals comprising a plurality of digital symbols, the method comprising the steps of:
calculating a plurality of digital symbols, comprised in a predetermined interval of each of the N multi-channel signals, to derive a calculated value;
repeating the calculating step to calculate a plurality of predetermined intervals to derive a plurality of calculated values;
counting the calculated values of the N multi-channel signals;
generating a plurality of statistical values according to the calculated values; and
screening the N channels to derive a first recognized channel and N−1 unrecognized channels according to the statistical values.

2. The method of claim 1, further comprising the steps of:
recognizing the N−1 unrecognized channels according to digital symbols respectively comprised in a first predetermined interval of the first recognized channel and a second predetermined interval of each of the N−1 unrecognized channels;
determining N−1 displacements between the N recognized channels; and
adjusting the multi-channel signals comprised in the N−1 recognized channels according to the N−1 displacements.

3. The method of claim 2, further comprising the steps of:
generating a determined value according to the digital symbols comprised in a determined interval of each of the N recognized channels; and
adjusting the polarity of the N recognized channels according to the determined values.

4. The method of claim 3, wherein a value of each of the digital symbols is one of −2, 0, and 2.

5. The method of claim 3, wherein the predetermined interval is two consecutive digital symbols beginning at an odd position or two consecutive digital symbols beginning at an even position.

6. The method of claim 3, wherein the calculating step calculates two consecutive digital symbols to derive the calculated value.

7. The method of claim 6, wherein the step of generating the statistical values comprises the steps of:
comparing the calculated value with a first predetermined value; and
modifying the statistical values according to the comparing result.

8. The method of claim 3, wherein the screening step comprises the steps of:
comparing the N−1 statistical values with a second predetermined value;
assigning the channels comprising the N−1 multi-channel signals corresponding to the N−1 statistical values as the N−1 unrecognized channels according to the compared result; and
assigning the channel comprising the remaining multi-channel signal as the first recognized channel.

9. The method of claim 3, wherein the step of generating the determined value of each of the N recognized channels comprises the steps of:
comparing each of the digital symbols with a third predetermined value;
performing a logical operation to the digital symbols comprised in a plurality of determined intervals of each of the N recognized channels to derive a logical value according to the comparing result; and
calculating the logical values to derive the determined value.

10. The method of claim 3, wherein the step of adjusting the polarity of the N recognized comprises the steps of:
determining a sign of the determined value; and
modifying a sign of each of the digital symbols according to the determining result.

11. The method of claim 3, wherein the digital symbols of each of the multi-channel signals are derived by simplifying a digital signal by a digital signal processor.

12. The method of claim 11, wherein the digital signal is derived by processing an analog signal by an analog-to-digital converter.

13. The method of claim 3, wherein the method is adapted for a gigabit Ethernet.

14. An apparatus for recognizing N channels according to N multi-channel signals, each of the N multi-channel signals comprises a plurality of digital symbols, the apparatus comprising:
a first calculating module for calculating a plurality of digital symbols, comprised in a predetermined interval of each of the N multi-channel signals, to derive a calculated value and for repeating the calculating step to calculate a plurality of predetermined intervals to derive a plurality of calculated values;
a statistical module for counting the calculated values of the N multi-channel signals and for generating a plurality of statistical values according to the calculated values; and
a screening module for screening the N channels to derive a first recognized channel and N−1 unrecognized channels according to the statistical values.

15. The apparatus of claim 14, further comprising:
a recognizing module for recognizing the N−1 unrecognized channels according to digital symbols respectively comprised in a first predetermined interval of the first recognized channel and a second predetermined interval of each of the N−1 unrecognized channels and for determining N−1 displacements between the N recognized channels; and
a first adjusting module for adjusting the multi-channel signals comprised in the N−1 recognized channels according to the N−1 displacements.

16. The apparatus of claim 15, further comprising:
a generating module for generating a determined value according to the digital symbols comprised in a determined interval of each of the N recognized channels; and
a second adjusting module for adjusting the polarity of the N recognized channels according to the determined values.

17. The apparatus of claim 16, wherein a value of each of the digital symbols is one of −2, 0, and 2.

18. The apparatus of claim 16, wherein the predetermined interval is two consecutive digital symbols beginning at an odd position or two consecutive digital symbols beginning at an even position.

19. The apparatus of claim 16, wherein the calculating step calculates two consecutive digital symbols to derive the calculated value.

20. The apparatus of claim 19, wherein the generating module comprises:
a comparing module for comparing the calculated value with a first predetermined value; and
a modifying module for adjusting the statistical values according to the comparing result.

21. The apparatus of claim 16, wherein the screening module comprises:
a first determining module for comparing the N−1 statistical values with a second predetermined value; and
an assigning module for assigning the channels comprising the N−1 multi-channel signals corresponding to the N−1 statistical values as the N−1 unrecognized channels according to the compared result, and for assigning the channel comprising the remaining multi-channel signal as the first recognized channel.

22. The apparatus of claim 16, wherein the generating module comprises:
a second determining module for comparing each of the digital symbols with a third predetermined value; and
a second calculating module for performing a logical operation to the digital symbols comprised in a plurality of determined intervals of each of the N recognized channels to derive a logical value according to the comparing result and for calculating the logical values to derive the determined value.

23. The apparatus of claim 16, wherein the second adjusting module comprises:
a third determining module for determining a sign of the determined value; and
a modifying module for modifying a sign of each of the digital symbols according to the determining result.

24. The apparatus of claim 16, wherein the digital symbols of each of the multi-channel signals are derived by simplifying a digital signal by a digital signal processor.

25. The apparatus of claim 24, wherein the digital signal is derived by processing an analog signal by an analog-to-digital converter.

26. The apparatus of claim 16, wherein the apparatus is adapted for a gigabit Ethernet.
